(19) United States
(12) Patent Application Publication
(10) Pub. No.: US 2008/0292277 A1
(43) Pub. Date: Nov. 27, 2008

(54) Apparatus and Method for Activating an Interactive Application

(75) Inventors: Liang Gan, Shanghai (CN); Jun Shi, Shanghai (CN); Jingwei Tan, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,948

(22) PCT Filed: Jul. 4, 2005
(86) PCT No.: PCT/IB2005/052207

§ 371 Date: Jan. 11, 2007

(30) Foreign Application Priority Data
Jul. 16, 2004 (CN) 200410054424.2

(51) Int. Cl. H04N 7/26

(52) U.S. Cl. 386/124; 386/E05.001

(57) ABSTRACT

An extracting apparatus (200) is arranged to extract a certain version of an object from an interactive application associated with a digital program, the extracting apparatus (200) comprises a receiving means (210) for receiving information regarding the version of the objet, an obtaining means (220) for obtaining a version type from the information, the version type indicating the certain version of the object is a replacement version, the replacement version is to replace a preceding version of the object stored on a storage medium, and a processing means (230) for processing the certain version of the object independency on the version type.

### FIELD OF THE INVENTION

The invention relates to a method of associating an interactive application to a digital program, the interactive application having a certain version of an object.

The invention further relates to a method of extracting a certain version of an object from an interactive application associated with a digital program.

The invention further relates to an extracting apparatus for extracting a certain version of an object from an interactive application associated with a digital program.

The invention further relates to a set-top box for extracting a certain version of an object from an interactive application associated with a digital program.

The invention further relates to a television set for extracting a certain version of an object from an interactive application associated with a digital program.

The invention further relates to a digital recorder for storing an interactive application associated with a digital program, the interactive application having a certain version of an object.

The invention further relates to a computer program product for extracting a certain version of an object from an interactive application associated with a digital program.

The invention further relates to a storage carrier containing such a computer program product.

### BACKGROUND OF THE INVENTION

European patent application with application number 04101740.1 describes a system and method for recording interactive television content and playback thereof, and particularly for handling of application data and associated audio/video data.

When recording interactive television an interactive application is stored separate from the audio/video content of a transport stream. During recording, correct synchronization between the audio/video content and the interactive application must be guaranteed. The patent application uses a unique timing based validating attribute being recorded together with the interactive application objects for synchronizing the audio/video content with the thereto related interactive application objects. According to embodiments, timestamps for when an item related to the interactive application is recorded, such as the AIT (Application Information Table) table, stream events etc., are used. During playback these timestamps are used to guarantee correct synchronization for stream events, DSMCC (Digital Storage Media Command and Control) module version control and for application validation timing.

### OBJECT AND SUMMARY OF THE INVENTION

It is an object of the invention to provide a method of associating an interactive application to a digital program offering a more flexible mechanism of associating the interactive application with the digital program. This objective is achieved in a method of associating an interactive application to a digital program, the interactive application having a certain version of an object, the method comprising:
receiving a version type of the certain version of the object, indicating the certain version of object is a replacement version, the replacement version is to replace a preceding version of the object stored on a storage medium,
generating the interactive application with the received version type, and
associating the generated interactive application to the digital program.

It is noted that the European application with application number 04101740.1 focuses on how to separately store an interactive application associated with a digital program and how to synchronize the interactive application with its corresponding audio/video parts during playback, but it does not mention how to replace a version of an object of the interactive application stored on a storage medium if there is such a need. For example, an interactive application is to dynamically update the score of a football match. A certain version of the score object should be “2-0”, but it is made to “0-2” by mistake during live play, thus it is also stored as “0-2”. During the playback, the viewer does not want to see this error again. So there is a need to replace the wrong version with a correct version.

According to the present invention there is a version type of the object that is a replacement version, the replacement version is to replace a preceding version of the object stored on a storage medium. An example of the replacement version is to correct the error described as in the above example. In this embodiment, a version of the object with the correct score “2-0” is created with its version type as “replacement version”, and it is sent to the viewer side to replace the wrong version of the object “0-2” stored on a storage medium. Thus during the playback, the viewer will not encounter this erroneous score again.

By using a version type of a version of an object that indicates the version of the object is a replacement version, and the replacement version replaces a preceding version of the object stored on a storage medium, the viewer will not see the erroneous score again. Comparing the present invention with the prior art: all versions of an object of an interactive application in the prior art are only to be presented during broadcasting. Thanks to the invention, the program maker has more flexible control of the objects of the interactive applications.

An embodiment of the method according to the invention is described in claim 3. In such an environment, the replacement version is also to replacement a preceding version of the object presented in real time, that is to say while the user is watching the broadcasting program. For example, the replacement version of score “2-0” will also replace the wrong score “0-2” presented on a display unit during broadcasting.

It is a further objective of the invention to provide a method of extracting a certain version of an object from an interactive application associated with a digital program offering a more flexible mechanism of extracting the object from the interactive application. This objective is achieved in a method of extracting a certain version of an object from an interactive application associated with a digital program, the method comprising:
receiving information regarding the certain version of the object,
obtaining a version type from the information, the version type indicating that the certain version of the object is a replacement version, the replacement version is to replace a preceding version of the object stored on a storage medium,
processing the certain version of the object in dependency on the version type. By using the version type, during broadcast of the digital program, at the receiving side, the certain version of the object can be processed in dependency on the version type. If the certain version of the object is a replacement version and the digital program is being recorded to a storage medium, the replacement version replaces a preceding version of the object on the storage medium. If the certain version of the object is not a replacement version and the digital program is being viewed, the certain version replaces the preceding version presented in real time.

An embodiment of the method according to the invention is described in claim 8. In such an environment, the replacement version is also to replace a preceding version of the object presented in real time.

It is a further objective of the invention to provide an extracting apparatus for extracting a certain version of an object from an interactive application associated with a digital program offering a more flexible mechanism of extracting the object from the interactive application. This object is achieved in an extracting apparatus comprising:
receiving means for receiving information regarding the version of the object,
obtaining means for obtaining a version type from the information, the version type indicating the certain version of the object is a replacement version, the replacement version is to replace a preceding version of the object stored on a storage medium,
processing means for processing the certain version of the object in dependency on the version type.

In the extracting apparatus according to the invention, when the information concerning the version of the object is received, the version type of the certain version of the object is acquired, which indicates the certain version of the object is a replacement version, the replacement version is to replace a preceding version of the object stored on a storage medium. Then the certain version of the object is sent to replace the preceding version of the object stored on a storage medium if the digital program is being recorded, or it is ignored.

It is a further objective of the invention to provide a set-top box for extracting a certain version of an object from an interactive application associated with a digital program, the objective is achieved in a set-top box comprising:
a receiver for receiving the digital program associated with the interactive application,
an extracting apparatus for extracting the certain version of the object from the interactive application associated with the digital program as described above.

It is a further objective of the invention to provide a television set for extracting a certain version of an object from an interactive application associated with a digital program, the objective is achieved in a television set comprising:
a receiver for receiving the digital program associated with the interactive application,
a display for displaying the digital program, and
an extracting apparatus for extracting the certain version of the object from the interactive application associated with the digital program as described above.

It is a further objective of the invention to provide a digital recorder for storing an interactive application associated with a digital program, the interactive application having a certain version of an object, the objective is achieved in a digital recorder comprising:
a receiver for receiving the digital program associated with the interactive application,
storing means for storing the digital program and the interactive application on a storage medium,
retrieving means for retrieving the digital program associated with the interactive application from the storage medium, and
an extracting apparatus for extracting the certain version of the object from the interactive application associated with the digital program as described above.

It is a further objective of the invention to provide a computer program product for extracting a certain version of an object from an interactive application associated with a digital program offering a more flexible mechanism of extracting the object from the interactive application. This objective is achieved in a computer program product comprising:
code for receiving information regarding the version of the object,
code for obtaining a version type from the information, the version type indicating the certain version of the object is a replacement version, the replacement version is to replace a preceding version of the object stored on a storage medium,
code for processing the certain version of the object in dependency on the version type.

### BRIEF DESCRIPTION OF THE DRAWINGS

The invention and its attendant advantages will be further elucidated with the aid of exemplary embodiments and the accompanying schematic drawings, wherein:

FIG. 1 shows a flow chart of associating an interactive application to a digital program according the invention,

FIG. 2 schematically shows the most important components of an extracting apparatus according to the invention,

FIG. 3 schematically shows a set-top box according to the invention,

FIG. 4 schematically shows a television set according to the invention, and

FIG. 5 schematically shows a digital video recorder according to the invention.

Corresponding features in the various Figures are denoted by the same reference symbols.

### DETAILED DESCRIPTION OF THE INVENTION

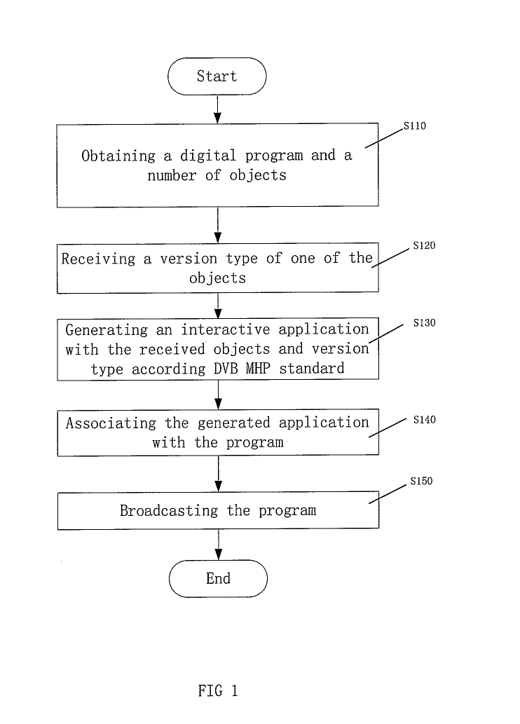

FIG. 1 shows a flow chart of associating an interactive application to a digital program according to the invention. Herein the interactive application does not mean this application shall be run with the involvement of the user of the digital program, but under some circumstances the interactive application can be run by itself. For example, a certain event such as a goal of a football match can trigger an interactive application presenting the introduction of the sportsman of the goal.

The digital program may contain an audio part, a video part and a data part. Compared to the interactive application, the audio, video and data part are played in a passive way for the user. In the DVB (Digital Video Broadcasting) standard, the digital program may contain zero or more video sub-streams, that is MPEG PES (Motion Picture Experts Group Packetized Elementary Stream), zero or more audio sub-streams, zero or more data sub-streams and service information. An extreme example of the digital program is that a digital program only contains service information.

The interactive application in the DVB MHP (Multimedia Home Platform) standard is transmitted in a Transport Stream (TS) inside modules through a Digital Storage Media Command and Control (DSMCC) object carousel. The objects in DSMCC include five kinds of object. There are: directory object, file object, stream event object, stream object and service gateway object, among which file object is the one of most interest to our invention.

The DSMCC modules are transmitted down a broadcast channel in the same TS as the Audio/Video content. The DSMCC object carousel defines how and when to send modules/files containing applications in the TS with the audio/video content. There is no connection to the server transmitting the TS for a receiving device to ask for wanted files. All files are repeatedly sent all the time, e.g. once every 10 seconds. Interactive television terminals, e.g. MHP terminals, such as a Set Top Box (STB), look for the files they need as they come around.

The data and attributes of one object, e.g. file, in an object carousel are transmitted in one message. The message format is referred to as the BIOP (Broadcast Inter ORB Protocol) Generic Object Message format (or BIOP message for short). A BIOP Message consists of a MessageHeader, a MessageSubHeader and a MessageBody.

The MessageHeader provides information about the version of the BIOP protocol and the length of the BIOP message. The MessageSubHeader contains information about the conveyed Object such as objectType (File, Stream, Directory, etc.) and objectKey (the unique identifier within a Module). The MessageBody depends on the objectType and contains the actual object's data. The size of a BIOP message is variable.

BIOP messages are broadcast in modules of object carousels. A module is formed by one or more concatenated BIOP Messages and is thus of variable length. Within the Module each object is identified by the objectKey. An object can easily be found by parsing subsequently the objectKey field of the BIOP message and the length of the BIOP message.

Each module is fragmented into one or more Blocks, which are carried in a DownloadDataBlock (DDB) message. Each DownloadDataBlock message is of the same size (except for the last block of the Module which may be of a smaller size) and is transmitted in turn in an MPEG2 private section as specified in ISO/IEC 13818-6. The encapsulation rules for DownloadDataBlock messages in MPEG2 private sections are such that Blocks can be acquired directly from the Transport Stream using hardware filters found generally on demultiplexers.

The acquisition of an object from the transport stream requires the complete acquisition of the module in which the object is contained. This requires knowledge of the delivery parameters of the Module such as module version, module size, block size, timing and broadcast channel. These delivery parameters are transmitted in a DownloadInfoIndication (DII) message as shown in Table 1, which has to be acquired from the network before acquiring the module. One DownloadInfoIndication message can describe the delivery parameters of multiple modules.

TABLE 1
DownloadInfoIndication (DII) message

| Syntax | Number of Bytes |
|---|---|
| DownloadInfoIndication( ) { | |
| dsmccMessageHeader( ) | |
| downloadId | 4 |
| blockSize | 2 |
| windowSize | 1 |
| ackPeriod | 1 |
| tCDownloadWindow | 4 |
| tCDownloadScenario | 4 |
| compatibilityDescriptor( ) | |
| numberOfModules | 2 |
| for(i = 0;i < numberOfModules;i++) { | |
| moduleId | 2 |
| moduleSize | 4 |
| moduleVersion | 1 |
| ‘moduleInfoLength | 1 |
| for(i = 0;i < moduleInfoLength;i++) { | |
| moduleInfoByte | 1 |
| } | |
| } | |
| privateDataLength | 2 |
| for(i = 0;i < privateDataLength;i++) { | |
| privateDataByte | 1 |
| } | |
| } | |

In table 1 there are two fields (see italics in table 1) that are of special interest to the present invention. One field is “moduleVersion”. As soon as one object in the module is changed, that means a new version of this object, the version number of the module “moduleVersion” is changed accordingly. Another field is “moduleInfoByte”, whose syntax is defined in table 2.

TABLE 2
BIOP::ModuleInfoByte syntax

| Syntax | | bits | Type | Value | Comment |
|---|---|---|---|---|---|
| BIOP::ModuleInfo( ) { | | | | | |
| | moduleTimeOut | 32 | uimsbf | + | |
| | blockTimeOut | 32 | uimsbf | + | |
| | minBlockTime | 32 | uimsbf | + | |
| | taps_count | 8 | uimsbf | N1 | 1 |

| { | | | | |
|---|---|---|---|---|
| id | 16 | uimsbf | 0x0000 | user private |
| use | 16 | uimsbf | 0x0017 | BIOP_OBJECT_{—} |

USE

| | | | |
|---|---|---|---|
| assocTag | 16 | uimsbf | + |
| selector_length | 8 | uimsbf | 0x00 |
| } | | | |

for (j=1; j<N1; j++) {

| id | 16 | uimsbf | + | |
|---|---|---|---|---|
| use | 16 | uimsbf | + | |
| assocTag | 16 | uimsbf | + | Possible |
| | | | | additional taps |
| | | | | that |
| selector_length | 8 | uimsbf | N2 | may be ignored |

| | by MHP |
|---|---|
| for (j=0; j<N2; | terminals. |

| j++) { | | | | |
|---|---|---|---|---|
| | selector_data | 8 | uimsbf | + |

}

| } | | | |
|---|---|---|---|
| userInfoLength | 8 | uimsbf | N3 |
| For (k=0; k<N3; | | | |
| k++) { | | | |

| | | | |
|---|---|---|---|
| userInfo_data | 8 | uimsbf | + |

}

}

According to the invention, a new parameter of an object, that is “version_type”, is introduced to offer a more flexible control of a certain version of the object. One embodiment of the syntax of this parameter is showed as table 3.

TABLE 3
Syntax of version_type_data

| Syntax | | Bits | Note |
|---|---|---|---|
| for (k=0; k<M; k++) { | | 8 | N1 (Not bigger |
| | objectKey_length | | than 0x04) |
| | for (i=0; i<N1; i++) { | | |

| | |
|---|---|
| objectKey_data_byte | 8 |

| } | | |
|---|---|---|
| version_type | 8 | uimsbf |
| if (version_type!=Normal) { | | |

| | |
|---|---|
| replaced_version_number | 8 |

}

}

In the above-described table 3, “M” is equal to the number of the objects in this module. By using this loop, each object can have its corresponding version type which can be one of the parameters as illustrated in the table 4.

“replaced_version_number” indicates the preceding version of the object stored on a storage medium is to be replaced. Its value depends on how the preceding version of the object is stored. For example, each stored version of the object has a suffix of its version number as a part of its file name, such as object_v1.txt, object_v2.txt, the value of “replaced_version_number” can be 1, which indicates object_v1.txt is to be replaced. This parameter could also be defined in other ways as long as the preceding version of the object to be replaced can be located in the storage medium.

TABLE 4
value of version_type

| Value | Version_type |
|---|---|
| 0x00 | Normal |
| 0x01 | Replace Storage |
| 0x02 | Replace Both |
| 0x03-0xFF | Reserved |

In the above-described table 4, “Normal” version_type indicates this version of an object is to replace a preceding version of the object being presented on a display unit, e.g. TV screen. The version of object with this type works in a similar way as a version of an object in the prior art. For example, a football match program compliant with the DVB standard is associated with an application including an object describing the status of the football match including the current score, cards, etc. The filename of this object remains matchfact_status.txt, but the content of the object changes over time. Whenever there is a status change, such as a score change, a new version of this object is created with the same name matchfact_status.txt and is broadcast. The receiver will catch the new version of the object from the transport stream and the new version will be used in the application. The old version is ignored and thus the score on the screen is updated.

Since the prior art only has this version type, there is no need for a parameter of version type. But according to the invention, more version types can be selected, so there is a need to have a parameter of version type. When a version of the object whose version type is “Normal” is created, it can have a parameter of version type to explicitly express its attribute. The version of the object also could make “Normal” as a default attribute, so the object does not explicitly show its attribute. Under this circumstance, any version of the object without version type parameter will be regared as “Normal”.

According to the invention, there are two kinds of replacement version type, one is “Replace Storage”, and the other is “Replace Both”.

“Replace Storage” indicates this version of the object is to replace a preceding version of the object being stored on a storage medium, e.g. a hard disc. The object can be stored on the storage medium in the way illustrated in European application with application number 04101740.1, Each version of the object can have its corresponding validating period, which represents its lifecycle. An example of the replacement version is to correct one of the preceding “Normal” versions of the object which has a wrong score number “0-2”. In this embodiment, a version of the object with the correct score “2-0” and with the same name “matchfact_status.txt” is created with its version type as “Replace Storage”, and it is sent to the viewer side to replace the wrong version of the object “0-2” stored on a storage medium. Thus when the stored digital program is played back, the viewer will not encounter this erroneous score again.

“Replace Both” indicates this version of the object is to replace a preceding version of the object being stored on a storage medium, e.g. a hard disc, and this version of the object is also to replace a preceding version of the object being presented on a display unit, e.g. TV screen. The object can be stored on the storage medium in the way illustrated in European application with application number 04101740.1. Each version of the object can have its corresponding validating period. An example of the replacement version is to correct one of the preceding “Normal” version of the object which has a wrong score number “0-2”. In this embodiment, a version of the object with the correct score “2-0” and with the same name “matchfact_status.txt” is created with its version type as “Replace Both”. The version of the object is sent to the viewer side to replace the wrong version of the object “0-2” stored on a storage medium. Thus when the stored digital program is played back, the viewer will not encounter this erroneous score again. The version of the object will also replace the preceding version of the object on the TV screen if the program is being viewed, the preceding version normally is the latest version showed on the screen.

Since in the DVB MHP standard the changes of the version of object version are reflected by the changes of the version of module version, the version type parameter is put into the information of module, e.g. DII information. The version type of an object is inserted in the userInfoLength field of DII as shown in Table 5.

TABLE 5
BIOP::ModuleInfo containing version_type_data syntax

| Syntax | | bits | Type | Value | Comment |
|---|---|---|---|---|---|
| BIOP::ModuleInfo( ) { | | | | | |
| | moduleTimeOut | 32 | uimsbf | + | |
| | blockTimeOut | 32 | uimsbf | + | |
| | minBlockTime | 32 | uimsbf | + | |
| | taps_count | 8 | uimsbf | N1 | 1 |

| | { | | | | |
|---|---|---|---|---|---|
| | id | 16 | uimsbf | 0x0000 | user private |
| | use | 16 | uimsbf | 0x0017 | BIOP_OBJECT_USE |
| | assocTag | 16 | uimsbf | + | |
| | selector_length | 8 | uimsbf | 0x00 | |
| | } | | | | |
| for (j=1; j<N1; j++) { | | | | | |
| | id | 16 | uimsbf | + | |
| | use | 16 | uimsbf | + | |
| | assocTag | 16 | uimsbf | + | Possible additional |
| | | | | | taps that |
| | selector_length | 8 | uimsbf | N2 | may be ignored by |

| | MHP |
|---|---|
| for (j=0; j<N2; j++) { | terminals. |

| | | | |
|---|---|---|---|
| selector_data | 8 | uimsbf | + |

}

| } | | | |
|---|---|---|---|
| userInfoLength | 8 | uimsbf | N3 |
| Version_type_data_length | 8 | | N4 |
| for (k=0; k<M; k++) { | | uimsbf | |

| | | | |
|---|---|---|---|
| objectKey_length | 8 | | N5 |
| for ( i=0; i<N5; i++) { | 8 | uimsbf | |

objectKey_data_by

te

| } | | |
|---|---|---|
| version_type | 8 | uimsbf |

| | |
|---|---|
| if (version_type!=Normal) | 8 |

{
replaced_version_numb
er

}
For (k=0; k<N3−N4−1; k++)
{

| | | | |
|---|---|---|---|
| userInfo_data | 8 | uimsbf | + |

}

It should be noted that the version types may have more choices which may use a number between 0x03 to 0xFF. Furthermore, the version types may be added to other areas in the information of the application as long as the version types of the object arrives at the user side no later than the version of the object.

It should be further noted that the application having a version of an object according to the invention could be associated to the digital program in other ways as long as the version type can be extracted when the digital program is being played/stored.

The flow chart of FIG. 1 shows how to associate an interactive application to a digital program according to the invention. This process can be completed by one of the various current program-making tools, such as Coral MHP.

First, a digital program and a number of objects are obtained (Step S110). The digital program may contain some A/V or data sub-streams as described above and service information. Each object has a corresponding version and is one part of an interactive application.

Secondly, a version type of one of the objects is received (Step S120). The version type can be one of the “version_type” defined above, such as “Replace Storage”, which means this version of object is a replacement version, the replacement version is to replace a preceding version of the object stored on a storage medium.

Thirdly, the interactive application with the received objects and version type according the DVB MHP standard is generated (Step S130). The data and attributes are encapsulated in one or more modules, and its corresponding DII. The version type is added to the DII message of the corresponding module.

Fourthly, the generated interactive application is associated with the digital program (Step S140). Each module is fragmented into one or more Blocks, which are carried in a DownloadDataBlock (DDB) message. Each DownloadDataBlock message is of the same size (except for the last block of the Module which may be of a smaller size) and is transmitted in turn in an MPEG2 private section.

It should be noted that the generating and associating process could be achieved in accordance with other current or future digital program making technology.

Finally, the digital program is broadcast (Step S150). It may be a satellite broadcast, a terrestrial broadcast or a cable broadcast.

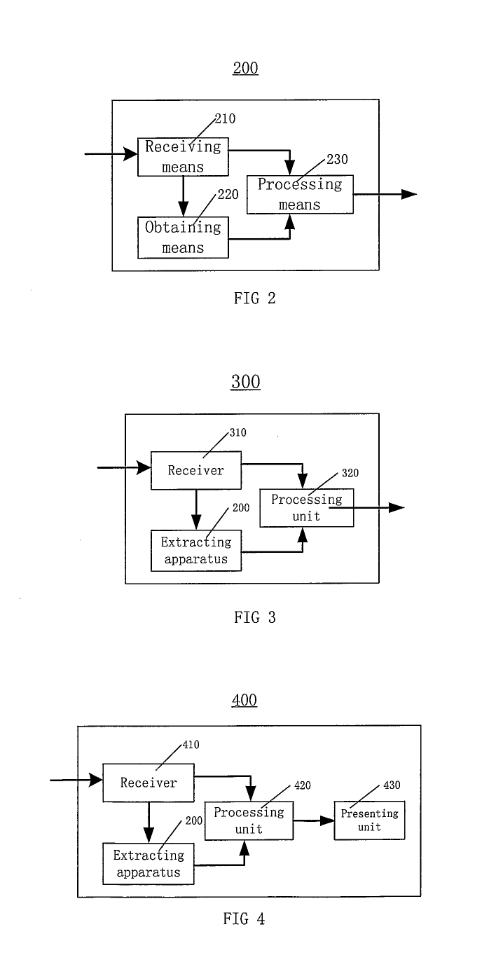

FIG. 2 schematically shows the most important components of an extracting apparatus according to the invention. The extracting apparatus is used for extracting a certain version of an object from an interactive application associated with a digital program. The extracting apparatus 200 has a receiving means 210, an obtaining means 220 and a processing means 230.

The receiving means 210 is used for receiving information regarding the version of the object. An example is that the receiving means 210 receives a DII message of a module having the certain version of object.

The obtaining means 220 is used for obtaining a version type from the information. An example is that the obtaining means 220 obtains a version type parameter from the DII information received by the receiving means 210.

The version type can be one of “version_type” as defined in table 4. For example, the version type is “Replace Storage”, which indicates the certain version of the object is a replacement version, the replacement version is to replace a preceding version of the object stored on a storage medium.

The processing means 230 is used for processing the certain version of the object in dependency on the version type.

An embodiment is that the version type obtained by the obtaining means 220 is “Normal”. In this embodiment, the corresponding module is extracted from the transportation stream, and the certain version of the object is acquired from the module as a new version of the object. The new version will be used in the application and the old version is ignored.

Another embodiment is that the version type obtained by the obtaining means 220 is “Replace Storage”. In this embodiment, if the digital program is being recorded, the certain version of the object is extracted from the transport stream and replaces the preceding version of the object stored on a storage medium as defined in the data of version type, e.g. “replaced_version_number”. The validating period of the replacement version stored on the storage medium is set to the same period as that of the preceding version of the object. If the digital program is not being recorded, the certain version of the object is ignored and will not be extracted from the transportation stream. The certain version of the object is not sent to the display unit in real time.

Still another embodiment is that the version type obtained by the obtaining means 220 is “Replace Both”. In this embodiment, if the digital program is being recorded and/or being viewed, the certain version of the object is extracted from the transport stream. The extracted object replaces the preceding version of the object stored on a storage medium as defined in the data of version type, e.g. “replaced_version_number” when the program is being recorded. The validating period of the replacement version stored on the storage medium is set to the same period as that of the preceding version of the object. The extracted object replaces a preceding version of the object being presented when the program is being viewed. The object being presented can only be the lateset version, under this circumstance, the preceding version of the object being presented is the previous latest version.

It should be noted there could be more situations that have not been illustrated above, if more version types were introduced.

The invention can also be implemented by means of a suitably programmed computer provided with a computer program for extracting a certain version of an object from an interactive application associated with a digital program. The computer program product for extracting a certain version of an object from an interactive application associated with a digital program comprises code for receiving information regarding the version of the object, code for obtaining a version type from the information, the version type indicating the certain version of the object is a replacement version, the replacement version is to replace a preceding version of the object stored on a storage medium, and code for processing the certain version of the object in dependency on the version type. Such a computer program product can be stored on a storage carrier.

These portions of program code may be provided to a processor to produce a machine, such that the code that executes on the processor create means for implementing the functions specified as above.

FIG. 3 schematically shows a set-top box according to the invention. The set-top box 300 contains a receiver 310 for receiving the digital program and the interactive application associated with the digital program, the interactive application having a certain version of an object. The digital program and the interactive application can be transmitted to the set-top box in one of various ways, such as by cable broadcast, by terrestrial broadcast or by satellite broadcast etc. The received digital program and interactive application are processed in the set-top box with a processing unit 320 and subsequently sent out for display or recording. The set-top box 300 further contains an extracting apparatus 200 as described above. The extracting apparatus 200 obtains a version type of the certain version of the object from the information received by the receiver 310, and processes the certain version of the object in dependency on the version type. Then the extracting apparatus 200 controls the processing unit 320 for conditionally processing the certain version of the object. If the version type obtained by the extracting apparatus 200 is “Replace Storage”, and if the digital program is being recorded, the certain version of the object is extracted from the transportation stream and replaces the preceding version of the object stored on a storage medium (not shown).

FIG. 4 schematically shows a television set according to the invention. The television set 400 contains a receiver 410 for receiving the digital program and the interactive application associated with the digital program, the interactive application having a certain version of an object. The digital program and the interactive application can be transmitted to the television set 400 in one of various ways, such as by cable broadcast, by terrestrial broadcast or by satellite broadcast and etc. The received digital program and interactive application are processed in the television set with a processing unit 420 to be displayed on a presenting unit 430, e.g. CRT. The television set 400 further contains an extracting apparatus 200 as described above. The extracting apparatus 200 obtains a version type of the certain version of the object from the information received by the receiver 410, and process the certain version of the object in dependency on the version type. Then the extracting apparatus 200 controls the processing unit 420 for conditionally processing the certain version of the object.

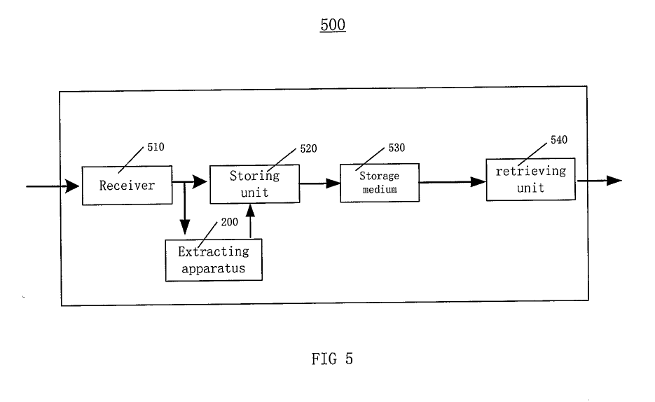

FIG. 5 schematically shows a digital recorder according to the invention. The digital recorder 500 contains a receiver 510 for receiving the digital program and the interactive application associated with the digital program, the interactive application having a certain version of an object. The digital program and the interactive application can be transmitted to the digital recorder 500 in one of various ways, such as by cable broadcast, by terrestrial broadcast or by satellite broadcast etc. The digital recorder 500 has a storing unit 520 for storing the digital program and the interactive application on a storage medium 530. This storage medium 530 is a hard disk, but other suitable media like a CD-RW may be used. The digital recorder 500 further has a retrieving unit 540 for retrieving the digital program associated with the interactive application from the storage medium 530. The retrieving unit 540 is used for played back a program stored by the recorder or the storage unit 520.

Furthermore, The digital recorder 500 contains an extracting apparatus 200 as described above. The extracting apparatus 200 obtains a version type of the certain version of the object from the information received by the receiver 510, and processes the certain version of the object in dependency on the version type. Then the extracting apparatus 200 controls the storing unit 520 for storing the certain version of the object on the storage medium 530. If the version type obtained by the extracting apparatus 200 is “Replace Storage”, the certain version of the object is extracted from the transportation stream and replaces the preceding version of the object stored on the storage medium 530.

Under certain circumstances, during the playback of the digital program, the version type of the object can be ignored.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the unit claims enumerating several means, several of these means can be embodied by one and the same item of hardware.

What is claimed is:

1. A method of associating an interactive application to a digital program, the interactive application having a certain version of an object, the method comprising:
receiving a version type of the certain version of the object, indicating the certain version of the object is a replacement version, the replacement version is to replace a preceding version of the object stored on a storage medium,
generating the interactive application with the received version type, and
associating the generated interactive application to the digital program.

2. A method as claimed in claim 1, wherein the interactive application is transmitted in a repeated way.

3. A method as claimed in claim 1, wherein the replacement version is to replace a preceding version of the object presented in real time.

4. A method as claimed in claim 1, wherein the digital program is a digital TV program compliant with Digital Video Broadcasting standard.

5. A method of extracting a certain version of an object from an interactive application associated with a digital program, the method comprising:
receiving information regarding the certain version of the object,
obtaining a version type from the information, the version type indicating that the certain version of the object is a replacement version, the replacement version is to replace a preceding version of the object stored on a storage medium,
processing the certain version of the object in dependency on the version type.

6. A method as claimed in claim 5, wherein the processing step includes replacing the preceding version of the object on the storage medium with the replacement version.

7. A method as claimed in claim 5, wherein each version of the object has its corresponding validating period, the validating period of the replacement version stored on the storage medium being set to the same period as that of the preceding version of the object.

8. A method as claimed in claim 5, wherein the processing step includes replacing the preceding version of the object presented in real time with the replacement version.

9. A method as claimed in claim 5, wherein the interactive application is transmitted in a repeated way.

10. An extracting apparatus for extracting a certain version of an object from an interactive application associated with a digital program, the extracting apparatus comprising:
receiving means for receiving information regarding the version of the object,
obtaining means for obtaining a version type from the information, the version type indicating the certain version of the object is a replacement version, the replacement version is to replace a preceding version of the object stored on a storage medium,
processing means for processing the certain version of the object in dependency on the version type.

11. A set-top box for extracting a certain version of an object from an interactive application associated with a digital program, the set-top box comprising:
a receiver for receiving the digital program associated with the interactive application,
an extracting apparatus for extracting the certain version of the object from the interactive application associated with the digital program as claimed in claim 10.

12. A television set for extracting a certain version of an object from an interactive application associated with a digital program, the television set comprising:
a receiver for receiving the digital program associated with the interactive application,
a display for displaying the digital program, and
an extracting apparatus for extracting the certain version of the object from the interactive application associated with the digital program as claimed in claim 10.

13. A digital recorder for storing an interactive application associated with a digital program, the interactive application having a certain version of an object, the digital recorder comprising:
a receiver for receiving the digital program associated with the interactive application,
storing means for storing the digital program and the interactive application on a storage medium,
retrieving means for retrieving the digital program associated with the interactive application from the storage medium, and
an extracting apparatus for extracting the certain version of the object from the interactive application associated with the digital program as claimed in claim 10.

14. A computer program product for extracting a certain version of an object from an interactive application associated with a digital program, the computer program product comprising:
code for receiving information regarding the version of the object,
code for obtaining a version type from the information, the version type indicating the certain version of the object is a replacement version, the replacement version is to replace a preceding version of the object stored on a storage medium,
code for processing the certain version of the object in dependency on the version type.

15. A storage carrier containing the computer program product as claimed in claim 14.
